(19) United States
(12) Patent Application Publication
(10) Pub. No.: US 2026/0285780 A1
(43) Pub. Date: Sep. 24, 2026

(54) ENERGETIC INK

(71) Applicant: U.S. Army DEVCOM, Army Research Laboratory, Adelphi, MD (US)

(72) Inventors: Philip M. Guerieri, Catonsville, MD (US); Katherine M. Ferguson, Columbia, MD (US); Erin L. Gawron-Hyla, Alexandria, VA (US)

(21) Appl. No.: 19/683,281

(22) Filed: May 20, 2026

Related U.S. Application Data
(62) Division of application No. 18/144,292, filed on May 8, 2023.

(51) Int. Cl. C06B 33/06; B60R 21/264; C06B 45/08; C06B 45/10

(52) U.S. Cl. CPC C06B 33/06; B60R 21/2644; C06B 45/08; C06B 45/10

(57) ABSTRACT

A technique for forming an energetic ink is provided. The technique includes forming a non-reactive layer by disposing a composite ink on a substrate, the composite ink including a polymer binder that is solvent-permeable and porous fuel particles (e.g. porous silicon particles). Mixing, printing, casting, assembling, or otherwise handling the inert composite can occur while it remains non-reactive. Subsequently, the technique can then include depositing a liquid solution of solid oxidizer onto the non-reactive layer, which can permeate the binder and impregnate the porous fuel particles with a solid oxidizer, activating the composite ink. In this manner, components with the composite ink can be partially and safely fabricated/assembled while the ink is inert, and the ink can then be activated at a later point in a manufacturing process.

### CROSS-REFERENCE TO RELATED APPLICATIONS

The present application claims priority to U.S. provisional patent application 63/388,674, filed Jul. 13, 2022, the entirety of which is incorporated by reference herein.

### GOVERNMENT INTEREST

The invention described herein may be manufactured and used by or for the Government of the United States for all governmental purposes without the payment of any royalty.

### FIELD OF THE DISCLOSURE

The present disclosure relates to inks, and printable energetic inks in particular.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Energetic material must be handled carefully, due to the safety hazard they inherently create. This creates limitations for what materials and devices the energetic material may be applied to. For example, 3D printing is now ubiquitous, yet energetic materials are rarely printed. Further, the substrate the energetic materials are printed onto must be chosen carefully.

### SUMMARY OF THE INVENTION

Various deficiencies in the prior art are addressed below by the disclosed compositions of matter and techniques.

In various aspects, a composite ink may be provided. The composite ink may include a plurality of particles. Each particle may be a metal or metalloid fuel and may have a plurality of internal pores. The composite ink may include a polymeric binder that is permeable to a desired solvent (such as, e.g., methanol).

In some embodiments, the metal or metalloid fuel may comprise or consist of aluminum, boron, carbon, or silicon. For example, in some embodiments, each particle may be a nano-porous silicon particle. In some embodiments, each internal pore may have an average pore diameter of 3-4 nm. In some embodiments, each particle has a porosity of 55-75%. In some embodiments, each pore exhibits hydrogen termination of all (or at least a portion of) an internal surface of the pore. In some embodiments, each particle has a diameter of 25 nm-100 nm.

In some embodiments, the ink may be configured to have a ratio of particles to polymeric binder, by weight, that is 80%-95% particles to 20%-5% polymeric binder.

In some embodiments, the composite ink may be free of a metal oxide.

In some embodiments, an oxidizer may be present within the plurality of internal pores. In some embodiments, the oxidizer may be a perchlorate (such as sodium perchlorate) or a nitrate (such as manganese nitrate).

In various aspects, a kit may be provided. The kit may include a composite ink and an oxidizer solution. The composite ink may include a plurality of particles, where the particles may be a metal or metalloid fuel with an internal porosity. The composite ink may include a polymeric binder that is permeable to a desired solvent. The composite ink should be free of an oxidizer. The oxidizer solution may include an oxidizer for the metal or metalloid fuel, and the desired solvent.

In various aspects, a system may be provided. The system may include a first substrate and a composite ink as disclosed herein. The composite ink may be disposed at a first location on at least one external surface of the first substrate. In some embodiments, the first substrate may be a metal, a fabric, a polymer, or a semiconductive material.

In various embodiments, the system may be configured for use in various applications. In some embodiments, the system may be configured for use with an airbag. That is, the system may be coupled to a source of a gas and may be coupled to a deflated balloon, such that when the ink is activated, the gas inflates the balloon. In some embodiments, the system may be used for welding; the system may include a second substrate configured to be coupled to the first substrate such that after activation of the composite ink, the second substrate is welded to the first substrate at the first location.

In various aspects, a method for forming an energetic material may be provided. The method may include disposing (e.g., via dipping, spraying, painting, printing, etc.) a composite ink onto a substrate to form a non-reactive layer. The composite ink may include a plurality of particles, each particle being a metal or metalloid fuel with a plurality of internal pores. The composite ink may include a polymeric binder that is permeable to a desired solvent. The method may include exposing the non-reactive layer to an oxidizer solution. The oxidizer solution may include an oxidizer for the metal or metalloid fuel and the desired solvent. The method may include allowing the oxidizer solution to infiltrate the plurality of internal pores and dry, where oxidizer remains within the plurality of internal pores after drying.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of a composite ink.

FIG. 2 is an illustration of an internal pore with an oxidizer.

FIG. 3 is an illustration of an embodiment of a kit.

FIG. 4 is an illustration of an embodiment of a system.

FIG. 5 is a simplified illustration of a pyrotechnic airbag inflator.

FIG. 6 is a simplified illustration of an embodiment of a system.

FIG. 7 is a flowchart of an embodiment of a method.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

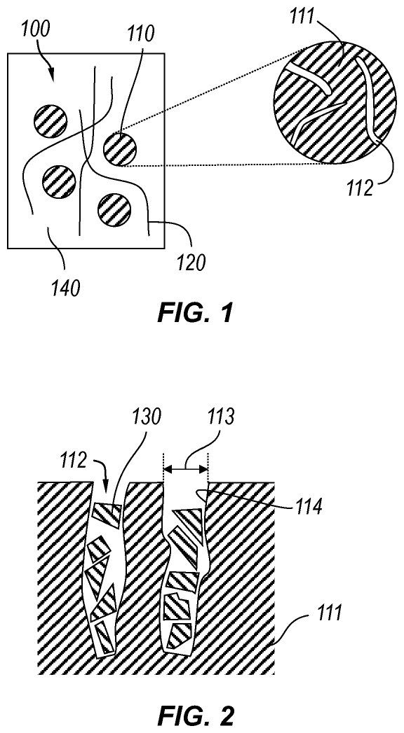

Referring to FIG. 1, a composite ink may be provided. The composite ink 100 may include a plurality of particles 110. Each particle may be a metal or metalloid fuel 111 and may have a plurality of internal pores 112. The composite ink may include a polymeric binder 120 that is permeable to a desired solvent (such as, e.g., methanol). In some embodiments, prior to being deposited, the ink may include a solvent 140 (that may be the desired solvent) or other carrier fluid. In some embodiments, the ink is free of such a solvent 140.

While any appropriate metal or metalloid material may be utilized here, in some embodiments, the metal or metalloid fuel may comprise or consist of aluminum, boron, carbon, or silicon. A preferred embodiment utilizes a porous silicon.

In some embodiments, the composite ink may be free of a metal oxide.

In some embodiments, each particle may have a diameter no more than 100 nm. In some embodiments, each particle may have a diameter of 25 nm-100 nm.

Referring briefly to FIG. 2, in some embodiments, each internal pore may have an average pore diameter 113 that is no more than 6 nm, no more than 5 nm, or no more than 4 nm. In some embodiments, the average pore diameter is at least 1 nm, at least 2 nm, or at least 3 nm. In preferred embodiments, the average pore diameter may be 3-4 nm. In some embodiments, each particle may be a nano-porous particle, such as nano-porous silicon particle. As used herein, the term “nanoporous” refers to an average pore diameter of between about 0.5 and about 6 nm.

In some embodiments, each particle has a porosity of at least 55%. In some embodiments, each particle has a porosity of 55-75%. The term “porosity” as used herein refers to a measure of the void spaces in a material and is reported as percentage between 0 and 100%.

Preferably, each pore exhibits hydrogen termination of all (or at least a portion of) an internal surface 114 of the pore 112.

In some embodiments, the ink may be configured to have a specific weight ratio of particles to polymeric binder. In some embodiments, the ink may be configured such that the weight of particles divided by the total weight of the particles and the polymeric binder is at least 30%, at least 50%, at least 60%, at least 70%, at least 80%, at least 85%, or at least 90%, and no more than 99%, 98%, 97%, 96%, 95%, 90%, 85%, 80%, 75%, or 70%, including all valid subranges thereof, the remainder being the polymeric binder. For example, in some embodiments, the ratio of particles to polymeric binder, by weight, may be 80%-95% particles to 20%-5% polymeric resin (which may can be written as 80%: 20% to 95%: 5%).

The polymeric binder may be any polymeric binder capable of being that is permeable to a desired solvent. The desired solvent is preferably a solvent with an evaporation rate greater than n-Butyl Acetate. Preferably, solvents with a single carbon in its backbone are utilized. A preferred solvent is methanol. Other solvents may include, e.g., acetone.

For a methanol solvent, non-limiting examples of a polymeric binder include e.g., NAFION™ sulfonated tetrafluoroethylene based fluoropolymer-copolymers sold by the Chemours Company, or cellulose acetate butyrate. Other methanol-permeable resins are well-known.

Referring to FIG. 2, in some embodiments, an oxidizer 130 may be present within the plurality of internal pores. In some embodiments, the oxidizer may be a perchlorate or a nitrate. In some embodiments, the oxidizer may be an oxide. Other oxidizers, appropriate for interacting with the fuel particles, may be utilized. Non-limiting examples of oxidizers include sodium perchlorate, potassium perchlorate, potassium nitrate, iron oxide, copper oxide, bismuth oxide, lead oxide, or a combination thereof.

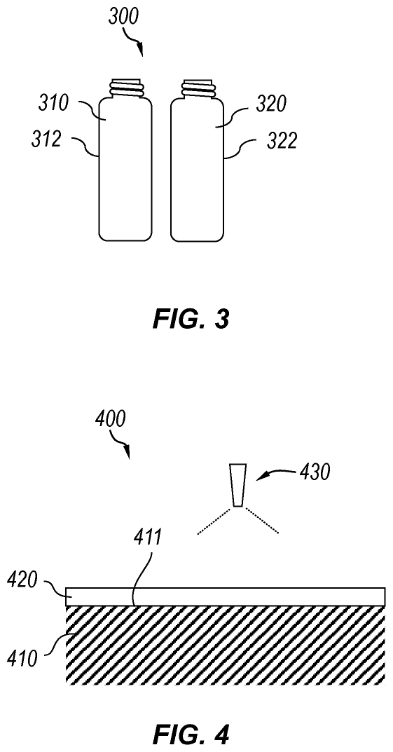

In various aspects, a kit may be provided. Referring to FIG. 3, in some embodiments, the kit 300 may include a composite ink 310 and an oxidizer solution 320. In some embodiments, the composite ink may include a plurality of particles, as disclosed herein, where the particles may be a metal or metalloid fuel with an internal porosity. The composite ink may include a polymeric binder, as disclosed herein, hat is permeable to a desired solvent. The composite ink should be free of an oxidizer.

In some embodiments, the oxidizer solution may include an oxidizer for the metal or metalloid fuel, as disclosed herein, and the desired solvent.

The composite ink may be provided in a first container 312, and the oxidizer solution may be provided in a second container 322. In some embodiments, the first container and the second container may be configured as removable cartridges for use with, e.g., a 3D printer.

In various aspects, a system may be provided. Referring to FIG. 4, in some embodiments, the system 400 may include a first substrate 410 and a composite ink 420 as disclosed herein. The composite ink may be disposed (e.g., via a known deposition process, such as via a spray nozzle 430) at a first location on at least one external surface 411 of the first substrate.

In some embodiments, the first substrate may be a metal, a fabric, a polymer, or a semiconductive material. In some embodiments, the first substrate may be a rigid substrate. In some embodiments, the substrate may be a flexible substrate. In some embodiments, the substrate may be non-porous. In some embodiments, the substrate may have macroscopic pores. In some embodiments, the substrate may be a woven or nonwoven fabric comprising a plurality of individual fibers.

In various embodiments, the system may be configured for use in various applications.

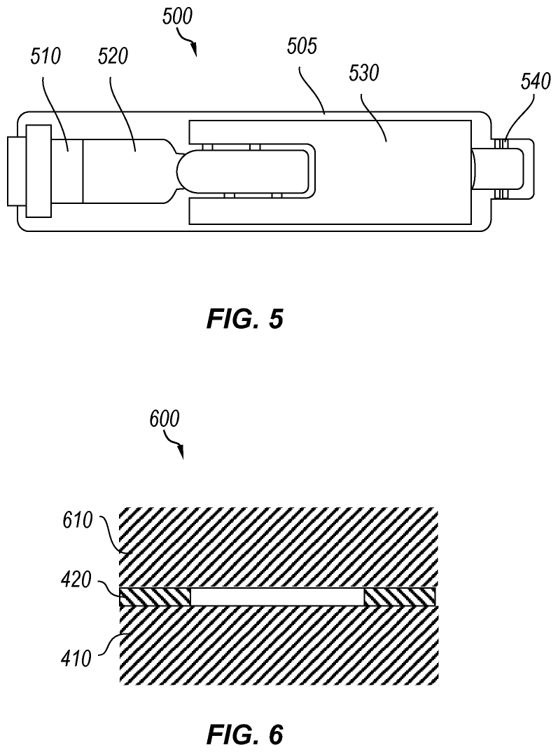

For example, referring to FIG. 5, in some embodiments, the system may be configured for use with an airbag. In FIG. 5, a simplified pyrotechnic inflator 500 can be seen, where an ignitor 510 at least partially within a housing 505 is coupled to a substrate 520 at least partially coated in the composite ink. When the ignitor activates the composite ink, gas generated will enter one or more additional chambers 530 before exiting through ports 540 in a diffuser nozzle which is then directed towards a folded/deflated airbag or balloon (not shown), inflating the airbag or balloon.

Alternatively, referring to FIG. 6, in some embodiments, the system may be used for welding (e.g., metal-to-metal welding). In the system 600 shown in FIG. 6, a second substrate 610 is provided, that can be disposed adjacent to a pattern of composite ink 420 on the first substrate. The second substrate is configured to be coupled to the first substrate; when the composite ink is activated (either via shock, ignition, etc.), the first and/or second substrate will be heated locally sufficiently to create a molten pool of metal at the location of the composite ink pattern(s), allowing the two substrates to be welded together at those locations. For example, if a composite ink at a first location is activated, the weld can be formed at the first location.

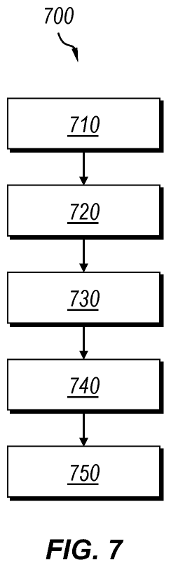

In various aspects, a method for forming an energetic material may be provided. Referring to FIG. 7, in some embodiments, the method 700 may include disposing 710 a composite ink onto a substrate to form a non-reactive layer. This may be done via any appropriate means for providing ink on the one or more surfaces of the substrate, including, e.g., dipping, spraying, painting, printing, etc. The composite ink may include a plurality of particles as disclosed herein, each particle being a metal or metalloid fuel with a plurality of internal pores. The composite ink may include a polymeric binder as disclosed herein, that is permeable to a desired solvent.

Optionally, the method may include allowing 720 the non-reactive layer to dry, harden, or cure.

Optionally, the method may include performing 730 one or more additional manufacturing steps related to the substrate, such as coupling the substrate to one or more additional components, heating, cooling, 3D printing other components around the substrate (so long as the composite ink remains accessible), shaping or modifying the substrate, etc.

The method may then include exposing 740 the non-reactive layer to an oxidizer solution. The oxidizer solution may include an oxidizer for the metal or metalloid fuel as disclosed herein, and the desired solvent. Any appropriate means for providing the oxidizer solution to the non-reactive layer may be utilized here, including, e.g., spraying via a spray nozzle, dispensing via a syringe, 3D printing, etc.

The method may include allowing 750 the oxidizer solution to infiltrate the plurality of internal pores and dry, where oxidizer remains within the plurality of internal pores after drying.

Thus, the presently disclosed techniques are capable of providing an energetic composite which is formed while inert using a polymer binder that is solvent-permeable and porous fuel particles. Mixing, printing, casting, assembling, or otherwise handling the inert composite can occur while it remains non-reactive. Subsequently, depositing a liquid solution of solid oxidizer onto the composite will permeate the binder and impregnate the porous fuel particles with a solid oxidizer, activating the otherwise non-reactive particles. Therefore, the composite can be partially and safely fabricated/assembled while inert and activated at a later point in a manufacturing process.

### EXAMPLES

Composite inks were produced that were composed of nano-porous silicon particles, binder, and solvent. Specific sizes of nano-porous silicon particles were achieved by sieving steps. Binders came in either a liquid dispersion or a powder. For binders in a dispersion, the binder was either used “as is” or was dried into films and then dissolved in the desired solvent. The choice of solvent depended on the solubility of the chosen binder. The consistency of the inks was modified by changing the amount of binder in the solvent (i.e., higher wt % binder solutions meant thicker inks due to less solvent content). The inks were mixed using two different methods depending on the application. The first ink batches made small quantities of inks in disposable 6-mL mixing cups. The nano-porous silicon particles were weighed out into disposable 6-mL mixing cups, the binder dissolved in solvent was added to make the desired nano-porous silicon: binder ratio, and then everything was mixed in a planetary mixer (Thinky ARE-250) for 2 min at 2000 rpm. After the ink was mixed, the ink was either scraped out onto a substrate or was transferred to a 1-mL syringe to be hand dispensed. The second mixing method made a larger batch of ink and was mixed and dispensed from the same 5-mL syringe. Nano-porous silicon particles were weighed out into a 5-mL syringe. The amount of binder in the solvent solution was then calculated and added to the 5-mL syringe. The excess air was carefully pushed out to minimize the mixing area and to ensure the syringe (with plunger) would fit into the mixer. The syringe was then mixed for 2 min at 2000 rpm. Once mixed, excess air was once again removed from the syringe and then the ink was hand dispensed onto the desired substrate. The choice of mixing method impacted the resulting ignition characteristics of the ink; therefore, the mixing method will be listed with each ink sample.

A couple of methanol-permeable binders were selected and tested. Several NAFION™ resins from Chemours were used. Additionally, Cellulose Acetate Butyrate (CAB) was explored as a potential binder. Several grades of CABs, along with a plasticizer (Optifilm OE 400), were obtained from Eastman Chemical Company and utilized. The binders were tested and compared with one another in terms of their ignition properties when combined with nano-porous silicon particles to form a composite ink.

An oxidizer solution was produced by dissolving sodium perchlorate in dry methanol to give a 50 wt % solution.

Appropriate amounts of the oxidizer solution can then be added to the composite ink to give a stoichiometric mixture for the reaction

Si+NaClO₄→2SiO₂+NaCl
and the solvent was allowed to evaporate. As will be understood, the stoichiometric equation will be different for different combinations of particles and oxidizers. The resulting product can then be further dried, e.g., at 60° C. in a vacuum drying over for 4-6 hours.

To ignite the composite ink samples, one or more of the following were used in this example: mechanical force, a spark, a hot wire, a flame torch, or a bridgewire. Mechanical force consisted of either scratching the sample or hitting it with a tool such as a screwdriver. A spark generator was used to generate a spark. One terminal was connected to Al foil or a metal plate that the ink samples were placed on and the other was positioned above the ink so the spark would generate between the two terminals and hit the ink sample. The hot wire was made using a nickel-chromium (NiCr) wire that was bent to a point and either side was attached to a power supply such that when a current was applied, the wire would heat up and thermally ignite the sample. A butane torch was used when no other methods would ignite the sample and it was simply lit and held to the sample until it ignited. For some experiments, a bridgewire was fabricated onto a Si wafer and used to ignite the composite ink sample.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. An energetic composite ink, comprising:
a plurality of metal or metalloid fuel particles, each metal or metalloid fuel particle having a plurality of internal pores;
a polymeric binder that is permeable to a desired solvent;
an oxidizer; and
wherein when the energetic composite ink is free of the oxidizer when the energetic composite ink is in an inert state, and the energetic composite ink comprises the oxidizer in the plurality of internal pores when the energetic composite ink has been activated.

2. The energetic composite ink according to claim 1, wherein the oxidizer is a perchlorate or a nitrate.

3. The energetic composite ink according to claim 2, wherein the oxidizer is a sodium perchlorate or a manganese nitrate.

4. A system, comprising:
a first substrate; and
an energetic composite ink disposed at a first location on at least one external surface of the first substrate, the energetic composite ink comprising:
a plurality of particles, each particle being a metal or metalloid fuel particle and having a plurality of internal pores; and
a polymeric binder that is permeable to a desired solvent.

5. The system according to claim 4, wherein the first substrate is a metal, a fabric, a polymer, or a semiconductive material.

6. The system according to claim 4, wherein the system is used with an airbag.

7. The system according to claim 4, wherein the system further comprises a second substrate coupled to the first substrate such that after activation of the energetic composite ink, the second substrate is welded to the first substrate at the first location.

8. The system according to claim 4, wherein the system further comprises an oxidizer solution comprising an oxidizer and the desired solvent, the oxidizer solution disposed on the energetic composite ink, activating the energetic composite ink by causing the oxidizer to be drawn into the plurality of internal pores.

9. A method for forming an energetic material, comprising:
disposing a composite ink in an inert configuration onto a substrate to form a non-reactive layer, the composite ink comprising:
a plurality of particles, each particle being a metal or metalloid fuel particle with a plurality of internal pores;
a polymeric binder that is permeable to a desired solvent;
exposing the non-reactive layer to an oxidizer solution comprising:
an oxidizer for the metal or metalloid fuel;
the desired solvent; and
activating the composite ink by allowing the oxidizer solution to infiltrate the plurality of internal pores and dry, where oxidizer remains within the plurality of internal pores after drying.

10. The method according to claim 9, wherein the composite ink is disposed on the substrate via dipping, spraying, painting, or printing.
